(19) United States
(12) Patent Application Publication
(10) Pub. No.: US 2009/0100945 A1
(43) Pub. Date: Apr. 23, 2009

(54) APPARATUS AND METHOD FOR SELF-ALIGNING A THERMAL CAP AND FOR CONNECTING TO A SOURCE OF TEMPERATURE-CONTROLLED FLUID

(75) Inventor: Jody T. Stiles, Boston, MA (US)

Correspondence Address: MILLS & ONELLO LLP, ELEVEN BEACON STREET, SUITE 605, BOSTON, MA, 02108, US

(73) Assignee: TEMPTRONIC CORPORATION, Sharon, MA (US)

(21) Appl. No.: 11/875,301

(22) Filed: Oct. 19, 2007

(51) Int. Cl. B65D 45/32; F16C 23/04; G01N 25/00

(52) U.S. Cl. 73/865.6; 384/192; 220/320

(57) ABSTRACT

A self-aligning device couples a temperature-controlled enclosure for a device under test to a source of temperature-controlled fluid and provides self-alignment of the temperature-controlled enclosure. The self-aligning device includes a bearing with a curved surface, a ring clamp with a curved surface and a tensioning bolt to control the amount of movement between the bearing and the ring clamp.

### FIELD OF THE INVENTION

This invention relates generally to a device for self-aligning a thermal cap to adjust to different testing surfaces and for connecting the thermal cap to a source of temperature-controlled fluid.

### DESCRIPTION OF THE RELATED ART

Hot and cold environmental test systems for quality assurance, characterization, failure analysis and production testing simulate the true temperature environment (−90° C. to 225° C.) to which devices, PCBs, modules and other components (each collectively referred to herein as a device under test (DUT)), will be exposed throughout their useful lives. These test systems provide quick, convenient thermal testing and cycling production testing, design verification and quality assurance.

FIGS. 1 and 2 illustrate a conventional test system. The test system includes a source of temperature-controlled fluid such as air, for example, ThermoStream model TP04300, TP04310, TP4500 or other such system, manufactured and sold by Temptronic Corporation of Sharon, Mass., that is used as an open-loop temperature source for controlling the temperature. A thermal cap 12 is attached to the source of temperature-controlled fluid 10 to protect from moisture condensation and frost at the DUT site. The thermal cap 12 attaches to the source of temperature-controlled fluid 10 ensuring proper coupling to the DUT and a localized thermal test environment. The thermal cap 12 includes two rings 14 and 16, preferably formed of glass such that the rings do not melt or fracture. Dry air is purged between the two rings 14 and 16 of glass from holes is an upper surface to prevent moisture from forming. The glass rings 14 and 16 are seated on a soft material 18 that is malleable, for example, silicone, foam or rubber. The thermal cap 12 further includes a vent 20.

Due to the rigidity of the interface between the thermal cap 12 and mounting plate of a head 22 of the source of temperature-controlled fluid 10, air can escape from between the thermal cap and the surface to which it is mating, for example, a device being tested or a foam rubber matting, allowing frost 24 to form on the device being tested and/or the surrounding area.

### SUMMARY OF THE INVENTION

According to a first aspect, the invention is directed to an apparatus having a bearing with a curved surface and a ring clamp having a curved surface which mates with the curved surface of the bearing surface and having a groove. A tensioning bolt is inserted in the groove of the ring clamp. The tension of the tensioning bolt couples the ring clamp to the bearing such that the position of the ring clamp is adjustable with respect to the bearing.

In one embodiment, the bearing comprises holes in a bottom surface of the bearing for coupling the bearing to a temperature-controlled enclosure for a device under test by screws inserted into the holes.

The ring clamp can include an indent for coupling the ring clamp to a source of temperature-controlled fluid by screws inserted into the indent.

In one embodiment, the position of the interface between the curved surface of the bearing and the curved surface of the ring clamp forms a joint. The joint can be adjustable in a plurality of directions to an angular deviation from the horizontal.

In one embodiment, the ring clamp comprises a split such that the tension of the tensioning bolt controls the amount of movement between the bearing and the ring clamp.

In one embodiment, grease is applied between the bearing and the ring clamp to reduce friction between the bearing and ring clamp.

In one embodiment, the bearing comprises aluminum with an anodized finish.

The bearing can include at least one of stainless steel, aluminum, carbon steel, ceramic alloys and amalgamations.

The ring clamp can comprise aluminum with an anodized finish.

The ring clamp can include at least one of stainless steel, aluminum, carbon steel, ceramic alloys and amalgamations.

According to another aspect, the invention is directed to a temperature control system which includes a source of temperature-controlled fluid and a temperature-controlled enclosure for a device under test. A self-aligning device is adapted and arranged to couple the source of temperature-controlled fluid to the temperature-controlled enclosure such that the position of the temperature-controlled enclosure is adjustable with respect to the source of temperature-controlled fluid.

In one embodiment, the self-aligning device comprises a bearing with a curved surface, a ring clamp having a curved surface which mates with the curved surface of the bearing surface and having a groove, and a tensioning bolt inserted in the groove of the ring clamp, wherein the tension of the tensioning bolt couples the ring clamp to the bearing such that the position of the ring clamp is adjustable with respect to the bearing. The bearing can include holes in a bottom surface of the bearing for coupling the bearing to the temperature-controlled enclosure by screws inserted into the holes. The ring clamp can include an indent for coupling the ring clamp to the source of temperature-controlled fluid by finger screws inserted into the indent.

The position of the interface between the curved surface of the bearing and the curved surface of the ring clamp can form a joint. The joint can be adjustable in a plurality of directions to an angular deviation from the horizontal.

In one embodiment, the ring clamp comprises a split such that the tension of the tensioning bolt controls the amount of movement between the bearing and ring clamp.

According to another aspect, the invention is directed to a method of providing a temperature controlled environment, comprising: coupling a source of temperature-controlled fluid to a temperature-controlled enclosure by a self-aligning device; adjusting the position of the temperature-controlled enclosure with respect to the source of temperature-controlled fluid using the self-aligning device such that a seal between the temperature-controlled enclosure and the device under test is created; and providing a temperature-controlled fluid from the source to the temperature-controlled enclosure for a device under test.

In one embodiment, the method further comprises: providing a joint between a curved surface of a bearing of the self-aligned device and a curved surface of a ring clamp of the self-aligning device; and inserting a tensioning bolt in a groove of the ring clamp, wherein the tension of the tensioning bolt couples the ring clamp to the bearing such that the position of the ring clamp is adjustable with respect to the bearing.

In one embodiment, the method further comprises coupling the bearing to the temperature-controlled enclosure by screws inserted into holes in a bottom surface of the bearing.

The method can further comprise coupling the ring clamp to the source of temperature-controlled fluid by finger screws inserted into an indent formed in the ring clamp.

In one embodiment, the joint is adjustable in a plurality of directions to an angular deviation from the horizontal.

In one embodiment, the ring clamp comprises a split such that the tension of the tensioning bolt controls the amount of movement between the bearing and ring clamp.

In one embodiment, the method further comprises applying grease to the joint between the curved surface of the bearing of the self-aligning device and the curved surface of the ring clamp of the self-aligning device.

### BRIEF DESCRIPTION OF THE DRAWINGS

The foregoing and other features and advantages of the invention will be apparent from the more particular description of preferred embodiments of the invention, as illustrated in the accompanying drawings, in which like reference characters refer to the same parts throughout the different views. The drawings are not necessarily to scale, emphasis instead being placed upon illustrating the principles of the invention.

FIG. 1 illustrates a conventional environmental test system.

FIG. 2 is a detailed view illustrating the conventional environmental test system of FIG. 1.

FIG. 3A is an exploded view of a self-aligning device, FIG. 3B is a top view of the self-aligning device of FIG. 3A, FIG. 3C and 3D are side views of the self-aligning device of FIG. 3A, and FIG. 3E is a cross-sectional view of the self-aligning device of FIGS. 3A, 3B, 3C and 3D, in accordance with an embodiment of the invention.

FIGS. 4A and 4B are side views of a bearing surface of the self-aligning device of FIGS. 3A-E, FIG. 4C is a cross-sectional view of the bearing surface of FIG. 4B, and FIG. 4D is a bottom view of the bearing surface of FIGS. 4A, 4B and 4C, in accordance with an embodiment of the invention.

FIGS. 5A, 5B and 5C are side views of a clamping collar of the self-aligning device of FIGS. 3A-3E, in accordance with an embodiment of the invention. FIG. 5D is a cross-sectional view of FIG. 5B, and FIG. 5E is a cross-sectional view of FIG. 5D, in accordance with an embodiment of the invention. FIG. 5F is a cross-sectional view of FIG. 5C, FIG. 5G is a detailed view of FIG. 5C, and FIG. 5H is a detailed view of FIG. 5F, in accordance with an embodiment of the invention.

FIG. 6 is a perspective view of a source of temperature-controlled fluid in accordance with an embodiment of the invention.

FIG. 7A is an exploded view of the self-aligning device of FIGS. 3A-E and a thermal cap, FIG. 7B is a top view of the self-aligning device of FIGS. 3A-E connected to the thermal cap, and FIG. 7C is a bottom view of thermal cap, in accordance with an embodiment of the invention. FIG. 7D is a side view of the self-aligning device of FIGS. 3A-3E connected to the thermal cap, FIG. 7E is a cross-sectional view of FIG. 7D, and FIG. 7F is a detailed view of FIG. 7E, in accordance with an embodiment of the invention.

FIG. 8A illustrates a source of temperature-controlled fluid being connected to the self-aligning device of FIGS. 3A-3E and a thermal cap, in accordance with an embodiment of the invention. FIG. 8B is a side view of the source of temperature-controlled fluid being connected to the self-aligning device and the thermal cap, FIGS. 8C and 8D are a cross-sectional views of FIG. 8B, and FIG. 8E is a detailed view of FIG. 8D, in accordance with an embodiment of the invention.

FIG. 9A is cross-sectional view of a source of temperature-controlled fluid being connected to the self-aligning device of FIGS. 3A-E and a thermal cap, FIG. 9B is a detailed view of FIG. 9A, and FIG. 9C is a detailed view of FIG. 9B, in accordance with an embodiment of the invention.

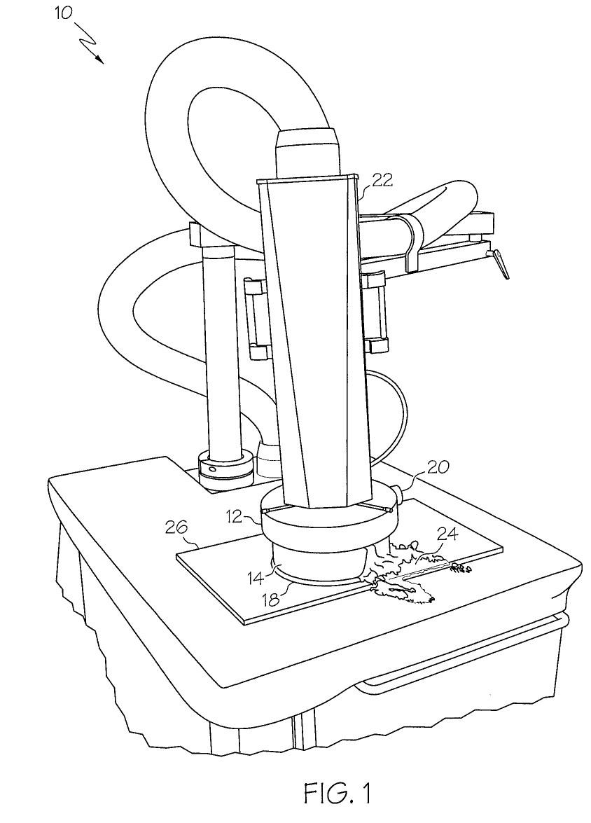

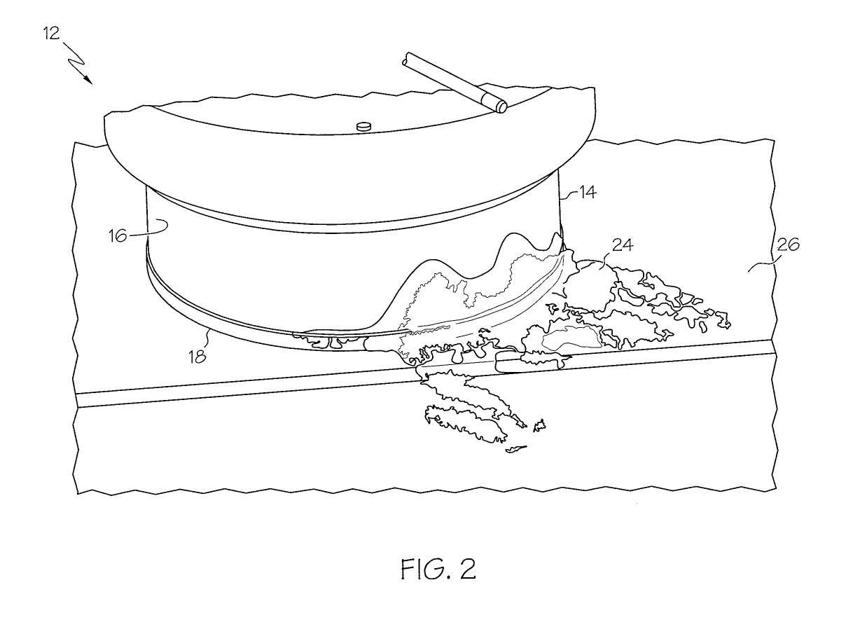

### DETAILED DESCRIPTION OF THE PREFERRED EMBODIMENT

The present invention re-aligns the head 22 of a source of temperature-controlled fluid 10 so as to minimize the possibility of an air gap forming. This is done by manually adjusting the head 22 until no air is felt flowing from between the thermal cap 12 and test surface 26.

By allowing the thermal cap to pivot independently of the head 22, alignment of the head 22 and test surface 26 prevents an air gap between the thermal cap 12 and test surface 26 thus reducing/eliminating the chance for frost to form.

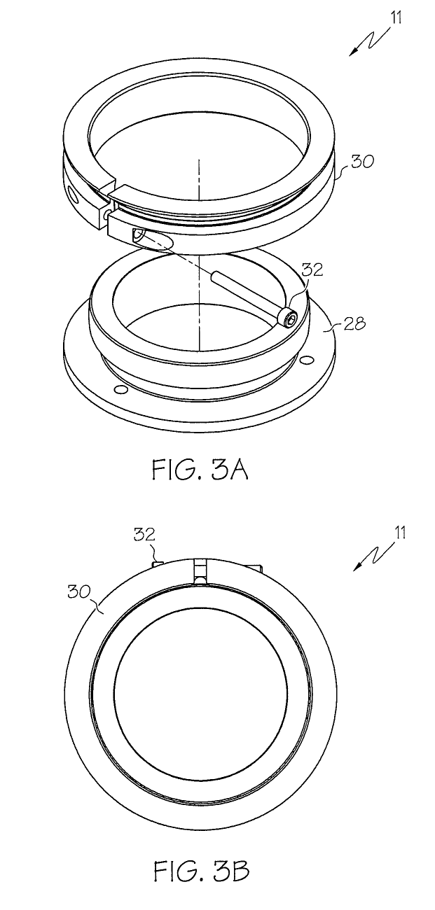

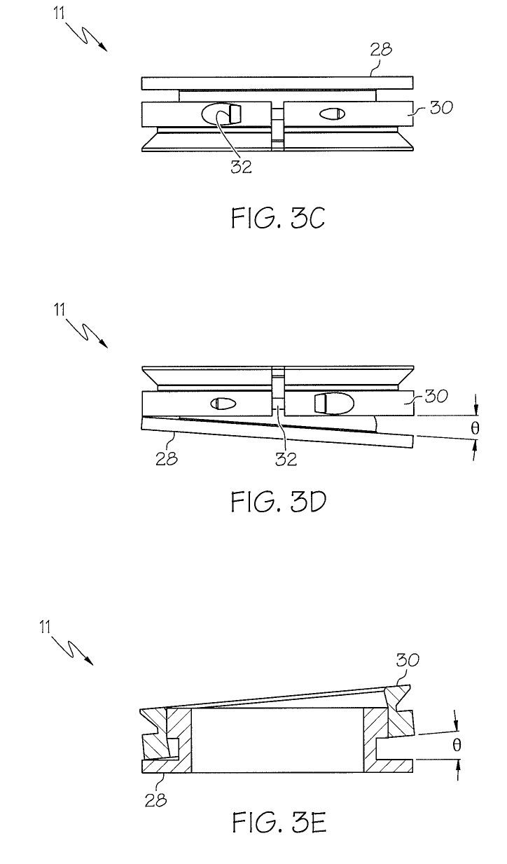

FIG. 3A is an exploded view of a self-aligning device, FIG. 3B is a top view of the self-aligning device of FIG. 3A, FIGS. 3C and 3D are side views of the self-aligning device of FIG. 3A, and FIG. 3E is a cross-sectional view of the self-aligning device of FIGS. 3A, 3B, 3C and 3D, in accordance with an embodiment of the invention. The self-alignment of the thermal cap is accomplished by using a self-aligning device 11 having a three-part assembly including a bearing surface 28 with a spherical profile, a clamping collar or a ring clamp 30 with similar bearing surface and profile, and a tensioning bolt 32 to control the amount of free floating of the assembly. As illustrated in FIGS. 3D and 3E, the joint is allowed to float, or move, in any direction to some angular deviation 0 from the horizontal, for example, to an approximate 5° maximum deviation from the horizontal.

The bearing surface 28 is preferably made from 6061 aluminum and, in one embodiment, it can have an anodized finish. Part of the bearing surface 28 can be made from billet stock and turned on a lathe or machined on a milling machine. Alternatively, materials for construction of the bearing surface 28 can be any of stainless steel, aluminum, carbon steel, or ceramic alloys and/or amalgamations.

The clamping collar 30 is preferably made from 6061 aluminum and, in one embodiment, it can have an anodized finish. Part of the clamping collar 30 can be made from billet stock and turned on a lathe or machined on a milling machine. Alternatively, materials for construction of the clamping collar 30 can be any of stainless steel, aluminum, carbon steel, or ceramic alloys and/or amalgamations.

The tensioning bolt 32 is preferably a 4-40 socket head cap screw made from stainless steel. An adjustable lever or similar device can be used in place of the tension bolt.

Grease is applied between the two bearing surfaces to reduce friction and increase the freedom of movement of the thermal cap 12 under the full operating temperature range of the source of temperature-controlled fluid 10. The grease is preferably Fomblin PerFluorinated grease, Type GRM 30 made by Solvay Solexis. Various greases with similar temperature range, mechanical and chemical properties similar to the Fomblin PerFluorinated grease, Type GRM 30 can be substituted.

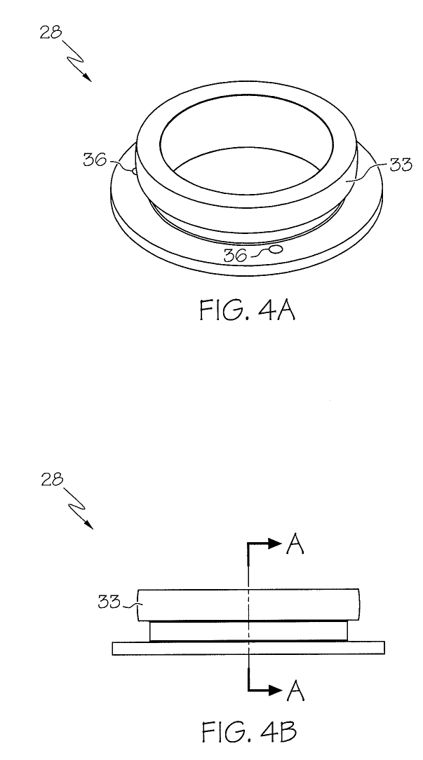

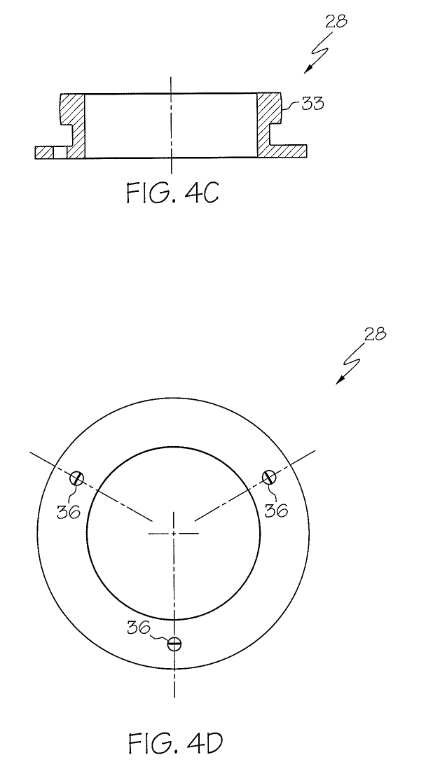

FIGS. 4A and 4B are side views of a bearing surface of the self-aligning device of FIGS. 3A-E, FIG. 4C is a cross-sectional view of the bearing surface of FIG. 4B, and FIG. 4D is a bottom view of the bearing surface of FIGS. 4A, 4B and 4C, in accordance with an embodiment of the invention. FIG. 4C is cross-sectional view of the spherical bearing surface 28 along section A-A of FIG. 4B. The spherical bearing surface 28 includes spherical side portions 33 for rotating with respect to inner side portions of the clamping collar 30, as illustrated in FIG. 3E. As illustrated in FIGS. 4A, 4C and 4D, the spherical bearing surface 28 includes first, second and third holes 36 spaced 120 degrees apart for connecting the spherical bearing surface 28 to the thermal cap 12.

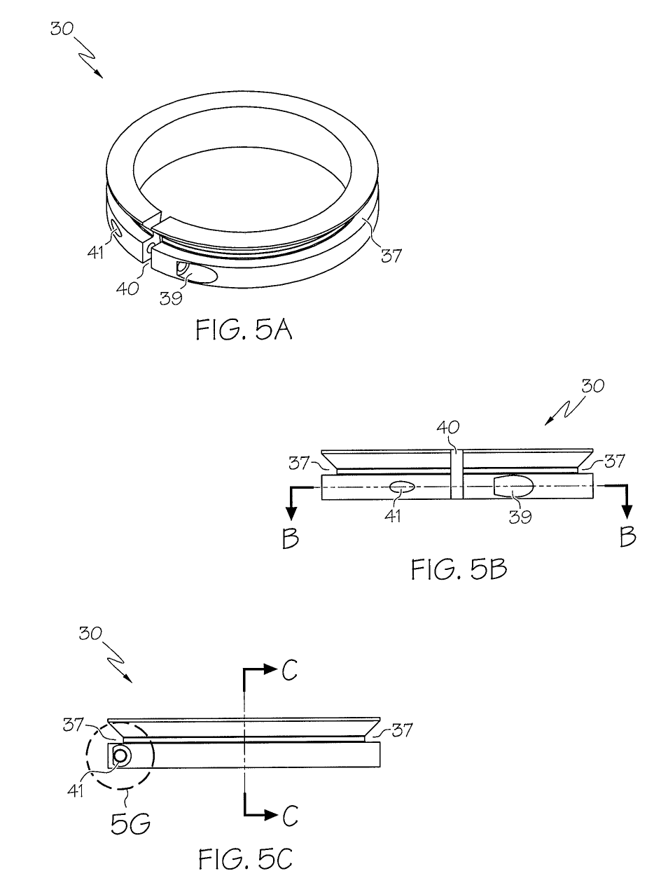

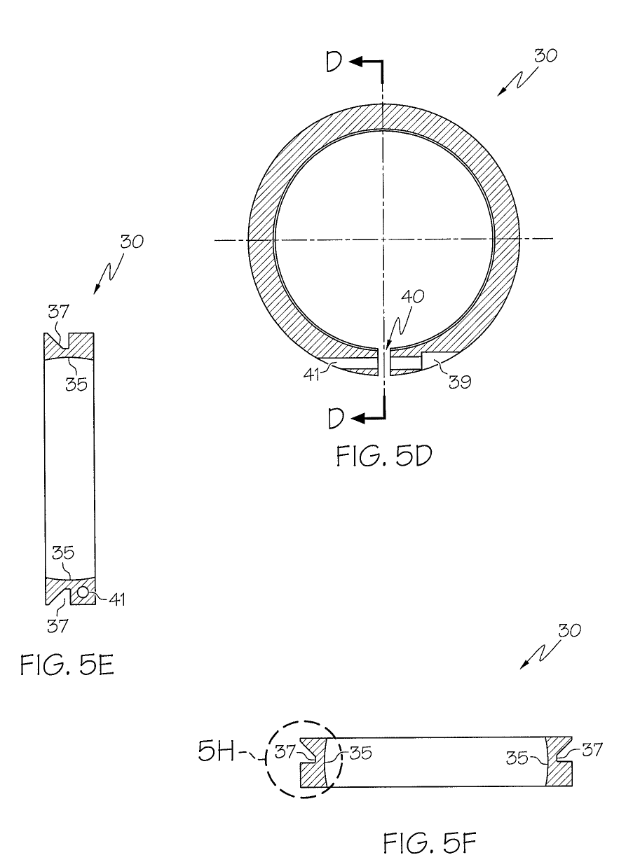

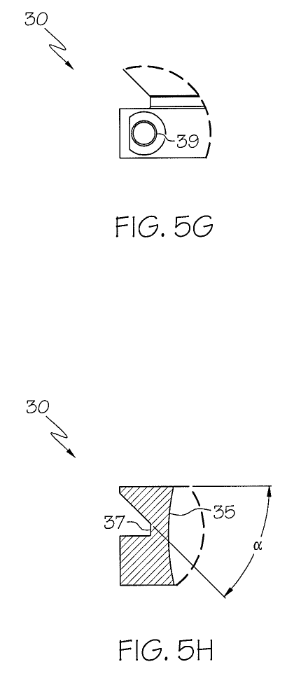

FIGS. 5A, 5B and 5C are side views of a clamping collar of the self-aligning device of FIGS. 3A, 3B, 3C and 3D in accordance with an embodiment of the invention. FIG. 5D is a cross-sectional view along section B-B of FIG. 5B and FIG. 5E is a cross-sectional view along section D-D of FIG. 5D, in accordance with an embodiment of the invention. FIG. 5F is a cross-sectional view along section C-C of FIG. 5C, FIG. 5G is a detailed view of FIG. 5C, and FIG. 5H is a detailed view of FIG. 5F in accordance with an embodiment of the invention. The clamping collar 30 includes spherical inner side surfaces 35 for interacting with the spherical side surfaces 33 of the spherical bearing surface 28 such that the self-aligning device 11 can be rotated to minimize the chance of an air gap forming, as illustrated in FIGS. 3D and 3E. The clamping collar 30 includes indent 37 into which three finger screws 38 are screwed to attach the source of temperature controlled fluid 10 to the clamping collar 30. FIG. 5H illustrates the spherical inner side surfaces 35 and the indent 37. FIGS. 5B and 5D illustrate the clamping collar 30 with a groove 39 and 41 and split 40. Tensioning bolt 32 is inserted into groove 39 and 41, and is tightened or loosened to provide less or more movement between the spherical bearing surface 28 and the clamping collar 30 by increasing or decreasing the size of the split 40. FIG. 5E illustrates the groove 41 through which the tensioning bolt 32 is inserted through from the split 40. FIGS. 5C and 5G illustrate the groove 39 through which the tensioning bolt 32 is inserted to the split 40.

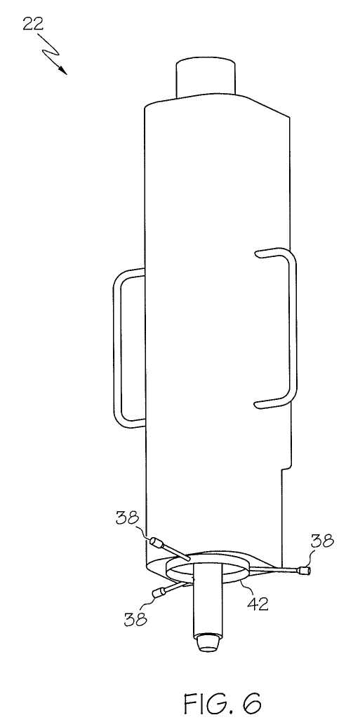

FIG. 6 is a perspective view of a portion of a source of temperature-controlled fluid in accordance with an embodiment of the invention. The head 22 of the source of temperature-controlled fluid 10 includes a ring 42 containing three finger screws 38 used to attach the clamping collar 30 to the head 22.

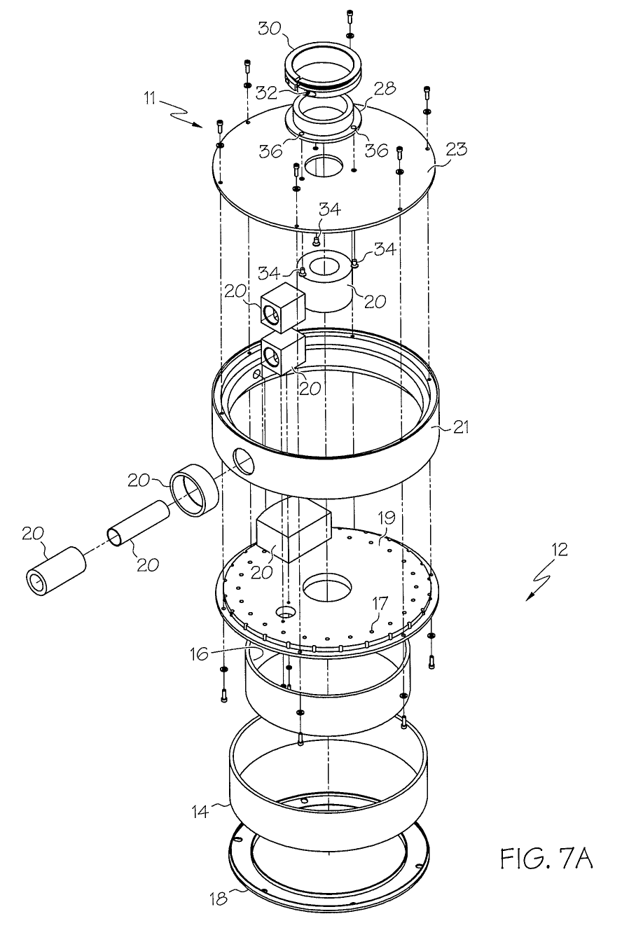

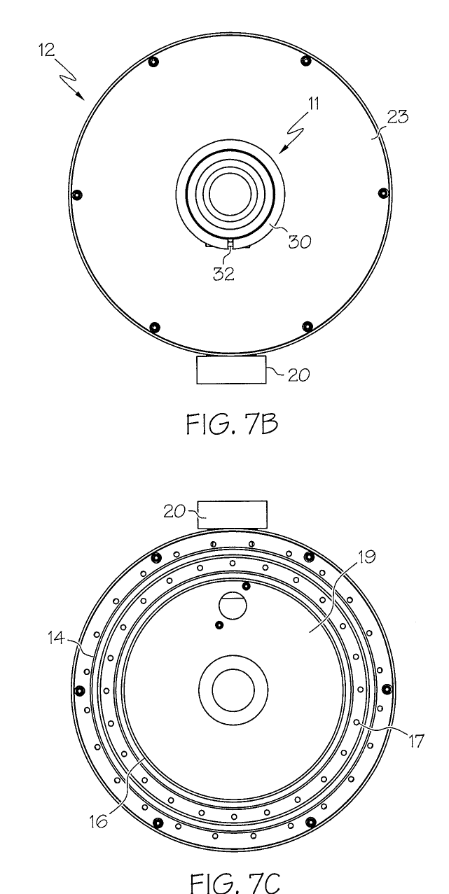

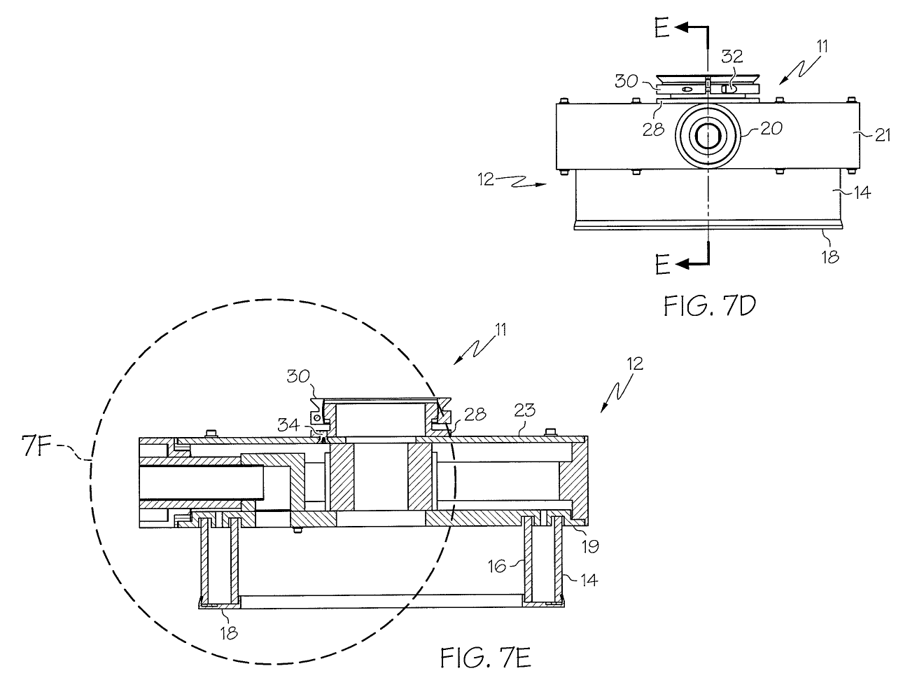

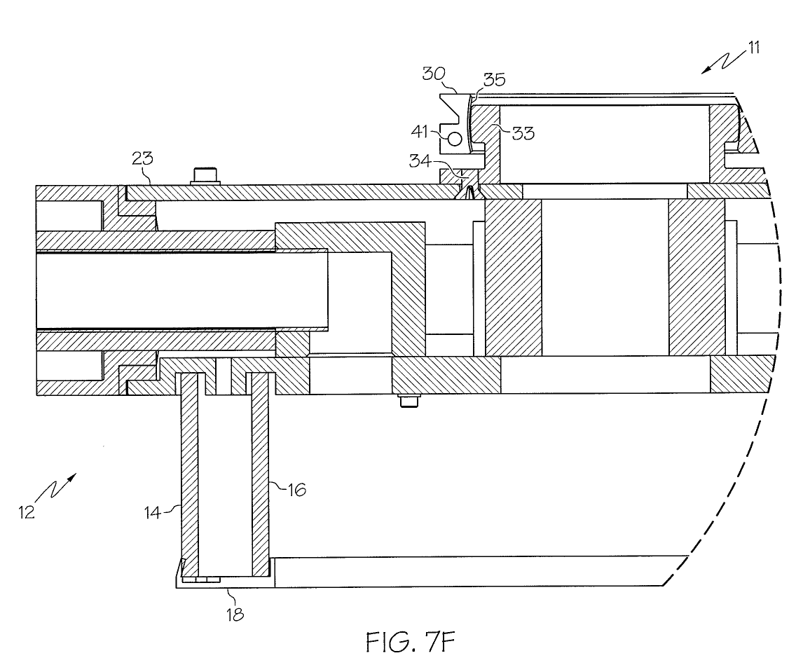

FIG. 7A is an exploded view of the self-aligning device of FIGS. 3A-E and a thermal cap, FIG. 7B is a top view of the self-aligning device of FIGS. 3A-E connected to the thermal cap, and FIG. 7C is a bottom view of thermal cap in accordance with an embodiment of the invention. FIG. 7D is a side view of the self-aligning device of FIGS. 3A-E connected to the thermal cap, FIG. 7E is a cross-sectional view along section E-E of FIG. 7D, and FIG. 7F is a detailed view of FIG. 7E in accordance with an embodiment of the invention.

The thermal cap 12 includes two rings 14 and 16, preferably formed of glass such that the rings do not melt or fracture. Dry air is purged between the two rings 14 and 16 of glass from holes 17 in a lower plate 19 connected to a top portion of the rings 14 and 16 to prevent moisture from forming. The glass rings 14 and 16 are seated on a soft material 18 that is malleable, for example, silicone, foam or rubber. An outer ring 21 is formed on the lower plate 19. The thermal cap 12 further includes a vent 20 formed in the outer ring 21 between the lower plate 19 and an upper plate 23. The self-aligning device 11 is connected to the thermal cap 12 on the upper plate 23. The bearing surface 28 is attached to the upper plate 23 of the thermal cap 12, preferably by use of three 6-32 flathead countersunk screws 34 which are inserted through holes 36.

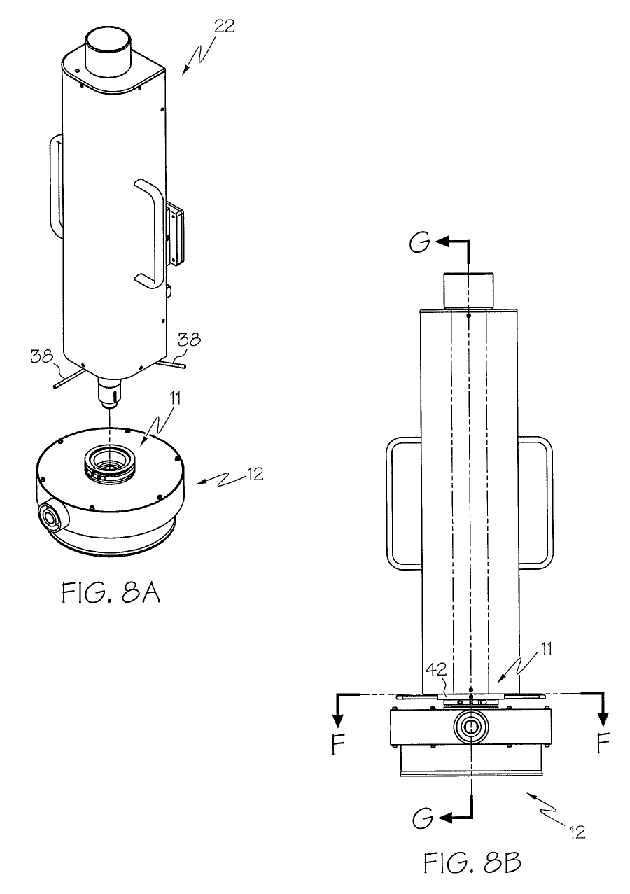

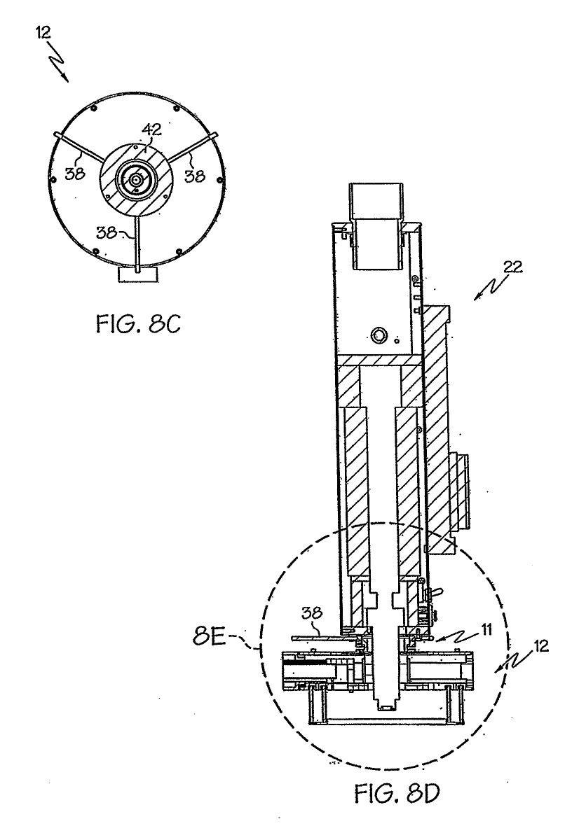

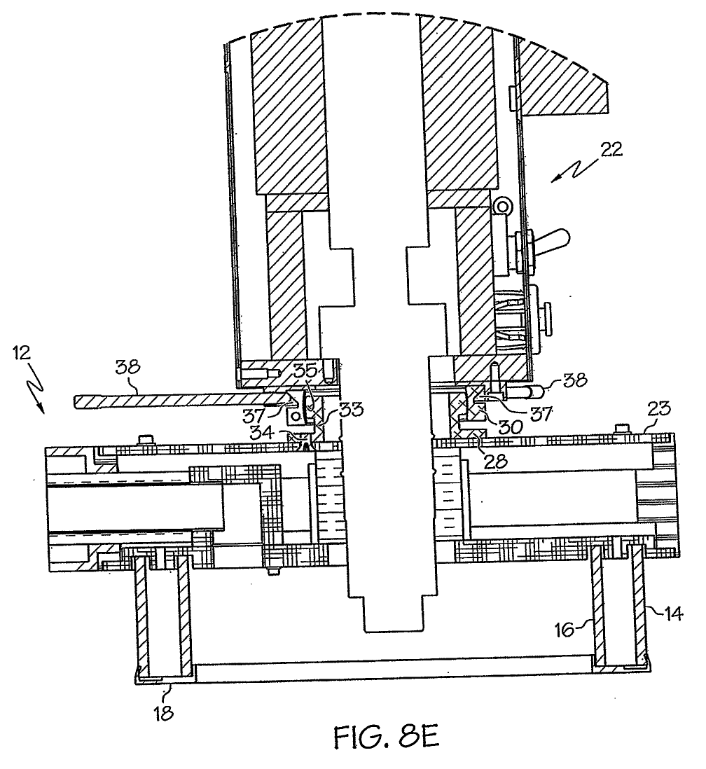

FIG. 8A illustrates a source of temperature-controlled fluid being connected to the self-aligning device of FIGS. 3A-3E and a thermal cap in accordance with an embodiment of the invention. FIG. 8B is a side view of the source of temperature-controlled fluid being connected to the self-aligning device and the thermal cap, FIGS. 8C and 8D are cross-sectional views along sections F-F and G-G of FIG. 8B, respectively, and FIG. 8E is detailed view of FIG. 8D, in accordance with an embodiment of the invention. FIGS. 8B, 8C, 8D and 8E illustrate the self-aligning device 11 coupled to the head 22 of the source of the temperature-controlled fluid 10 and the thermal cap 12. The clamping collar 30 of the self-aligning device 11 is attached to the head 22 of the source of temperature-controlled fluid 10 via the ring 42 containing three finger screws 38 used to clamp the clamping collar 30 in indent 37. The three finger screws 38 can be tightened to secure the source of the temperature-controlled fluid 10 to the self-aligning device 11. The bearing surface 28 of the self-aligning device 11 is attached to the upper plate 23 of the thermal cap 12, preferably by use of three 6-32 flathead countersunk screws 34 which are inserted through holes 36 of the bearing surface 28.

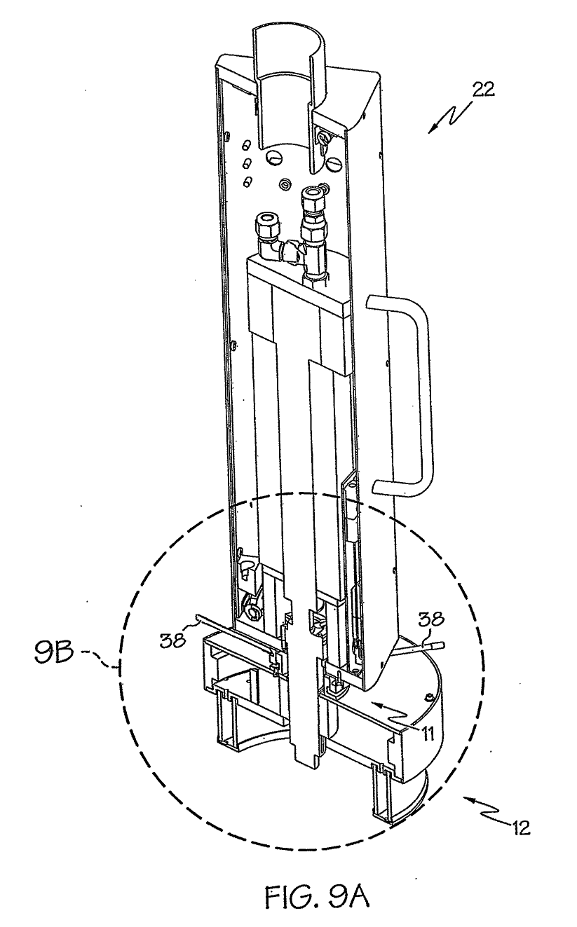

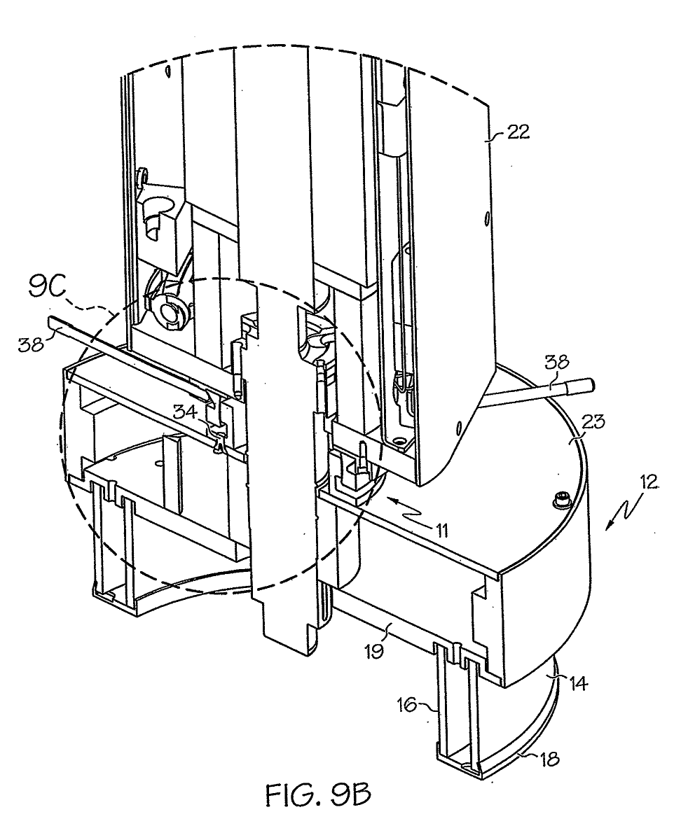

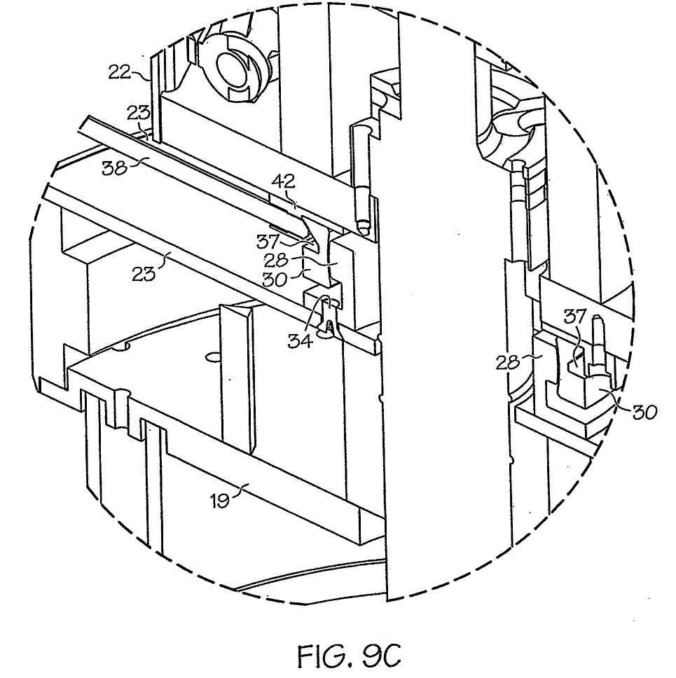

FIG. 9A is cross-sectional view of a source of temperature-controlled fluid connected to the self-aligning device of FIGS. 3A, 3B and 3C and a thermal cap, FIG. 9B is a detailed view of FIG. 9A, and FIG. 9C is a detailed view of FIG. 9B in accordance with an embodiment of the invention. FIGS. 9B and 9C illustrate the self-aligning device 11 coupled to the source of the temperature-controlled fluid 10 and the thermal cap 12.

The self-aligning thermal cap of the present invention provides the floating ability of the spherical bearing surface 28 and the infinitely adjustable tension between the bearing surface 28 of the inner and outer components by use of the tensioning bolt 32.

The incorporation of an articulating joint design to the interface between the thermal cap and the source of temperature-controlled fluid head 22 removes the need for the system operator to adjust the position of the source of temperature-controlled fluid head 22 for each testing procedure thus reducing the amount of time required for setup.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An apparatus comprising:
a bearing with a curved surface;
a ring clamp having a curved surface which mates with the curved surface of the bearing surface and having a groove; and
a tensioning bolt inserted in the groove of the ring clamp, wherein the tension of the tensioning bolt couples the ring clamp to the bearing such that the position of the ring clamp is adjustable with respect to the bearing.

2. The apparatus of claim 1, wherein the bearing comprises holes in a bottom surface of the bearing for coupling the bearing to a temperature-controlled enclosure for a device under test by screws inserted into the holes.

3. The apparatus of claim 1, wherein the ring clamp comprises an indent for coupling the ring clamp to a source of temperature-controlled fluid by screws inserted into the indent.

4. The apparatus of claim 1, wherein the position of the interface between the curved surface of the bearing and the curved surface of the ring clamp forms a joint.

5. The apparatus of claim 4, wherein the joint is adjustable in a plurality of directions to an angular deviation from the horizontal.

6. The apparatus of claim 1, wherein the ring clamp comprises a split such that the tension of the tensioning bolt controls the amount of movement between the bearing and the ring clamp.

7. The apparatus of claim 1, wherein grease is applied between the bearing and the ring clamp to reduce friction between the bearing and ring clamp.

8. The apparatus of claim 1, wherein the bearing comprises aluminum with an anodized finish.

9. The apparatus of claim 1, wherein the bearing comprises at least one of stainless steel, aluminum, carbon steel, ceramic alloys and amalgamations.

10. The apparatus of claim 1, wherein the ring clamp comprises aluminum with an anodized finish.

11. The apparatus of claim 1, wherein the ring clamp comprises at least one of stainless steel, aluminum, carbon steel, ceramic alloys and amalgamations.

12. A temperature control system, comprising:
a source of temperature-controlled fluid;
a temperature-controlled enclosure for a device under test; and
a self-aligning device that is adapted and arranged to couple the source of temperature-controlled fluid to the temperature-controlled enclosure such that the position of the temperature-controlled enclosure is adjustable with respect to the source of temperature-controlled fluid.

13. The temperature control system of claim 12, wherein the self-aligning device comprises:
a bearing with a curved surface;
a ring clamp having a curved surface which mates with the curved surface of the bearing surface and having a groove; and
a tensioning bolt inserted in the groove of the ring clamp, wherein the tension of the tensioning bolt couples the ring clamp to the bearing such that the position of the ring clamp is adjustable with respect to the bearing.

14. The temperature control system of claim 13, wherein the bearing comprises holes in a bottom surface of the bearing for coupling the bearing to the temperature-controlled enclosure by screws inserted into the holes.

15. The temperature control system of claim 13, wherein the ring clamp comprises an indent for coupling the ring clamp to the source of temperature-controlled fluid by finger screws inserted into the indent.

16. The temperature control system of claim 13, wherein the position of the interface between the curved surface of the bearing and the curved surface of the ring clamp forms a joint.

17. The temperature control system of claim 16, wherein the joint is adjustable in a plurality of directions to an angular deviation from the horizontal.

18. The temperature control system of claim 13, wherein the ring clamp comprises a split such that the tension of the tensioning bolt controls the amount of movement between the bearing and ring clamp.

19. A method of providing a temperature controlled environment, comprising:
coupling a source of temperature-controlled fluid to a temperature-controlled enclosure by a self-aligning device;
adjusting the position of the temperature-controlled enclosure with respect to the source of temperature-controlled fluid using the self-aligning device such that a seal between the temperature-controlled enclosure and the device under test is created; and
providing a temperature-controlled fluid from the source to the temperature-controlled enclosure for a device under test.

20. The method of claim 19, further comprising:
providing a joint between a curved surface of a bearing of the self-aligned device and a curved surface of a ring clamp of the self-aligning device; and
inserting a tensioning bolt in a groove of the ring clamp, wherein the tension of the tensioning bolt couples the ring clamp to the bearing such that the position of the ring clamp is adjustable with respect to the bearing.

21. The method of claim 20, further comprising coupling the bearing to the temperature-controlled enclosure by screws inserted into holes in a bottom surface of the bearing.

22. The method of claim 20, further comprising coupling the ring clamp to the source of temperature-controlled fluid by finger screws inserted into an indent formed in the ring clamp.

23. The method of claim 20, wherein the joint is adjustable in a plurality of directions to an angular deviation from the horizontal.

24. The method of claim 20, wherein the ring clamp comprises a split such that the tension of the tensioning bolt controls the amount of movement between the bearing and ring clamp.

25. The method of claim 20, further comprising applying grease to the joint between the curved surface of the bearing of the self-aligning device and the curved surface of the ring clamp of the self-aligning device.
